(19) United States
(12) Patent Application Publication
(10) Pub. No.: US 2019/0158245 A1
(43) Pub. Date: May 23, 2019

(54) UPLINK REFERENCE SIGNAL TRANSMISSION METHOD AND APPARATUS

(71) Applicant: HUAWEI TECHNOLOGIES CO., LTD., SHENZHEN (CN)

(72) Inventors: Kun ZENG, Chengdu (CN); Guangjian WANG, Chengdu (CN); Kunpeng LIU, Chengdu (CN)

(21) Appl. No.: 16/250,741

(22) Filed: Jan. 17, 2019

Related U.S. Application Data
(63) Continuation of application No. PCT/CN2017/087209, filed on Jun. 5, 2017.

(30) Foreign Application Priority Data
Jul. 22, 2016 (CN) 201610585098.0

(51) Int. Cl. H04L 5/00; H04W 56/00; H04W 72/04

(52) U.S. Cl. CPC H04L 5/0048; H04W 72/044; H04W 56/001

(57) ABSTRACT

A method includes determining, by a terminal, a time domain resource sending position of an uplink reference signal of the terminal on a high frequency link, where there is a guard interval at at least one end of the uplink reference signal, after arriving at the time domain resource sending position, switching transmit beams in different time slices in M time slices to transmit the uplink reference signal, where the uplink reference signal includes uplink reference signals transmitted in the M different time slices, and determining, by a high frequency base station, N time slices that are used to receive an uplink reference signal transmitted by the terminal in a single time slice of the terminal, and switching receive beams in different time slices in the N time slices to receive the uplink reference signal of the terminal.

### CROSS-REFERENCE TO RELATED APPLICATIONS

This application is a continuation of International Application No. PCT/CN2017/087209, filed on Jun. 5, 2017 which claims priority to Chinese Patent Application No. 201610585098.0, filed on Jul. 22, 2016. The disclosures of the aforementioned applications are hereby incorporated by reference in their entireties.

### TECHNICAL FIELD

The present disclosure relates to the field of wireless technologies, and in particular, to an uplink reference signal transmission method and apparatus.

### BACKGROUND

In hybrid networking of a high frequency base station and a low frequency base station, also referred to as heterogeneous networking (HetNet) of the high frequency base station and the low frequency base station, the low frequency base station covers a relatively large area, and the high frequency base station provides hotspot coverage in the coverage of the low frequency base station, to improve a capacity of a hotspot region. In this networking mode, system overheads of control signaling transmission on a high-frequency directional link can be reduced by using a wide coverage capability of the low frequency base station, and therefore this networking mode is a key deployment scenario in future 5G.

In an existing LTE system, Softcell networking is a typical HetNet networking solution. In the Softcell networking, a micro/pico base station (micro/pico BS) reuses a cell ID of a macro base station (macro BS). In other words, the micro base station is transparent for a terminal (for example: User Equipment (UE)). When accessing a network, the terminal knows only an ID of an entire HetNet cell or a macro base station ID, and does not need to know a micro base station that serves the terminal. In this networking solution, to implement synchronization between the terminal and the micro base station, the existing technical solution is as follows:

(1) The terminal completes a downlink synchronization process with the macro base station by detecting a primary/secondary synchronization signal (PSS/SSS) of a cell, to obtain a synchronization clock on a network side.

(2) The terminal completes an uplink physical random access process to obtain an uplink timing advance (TA) from the terminal to the macro base station.

(3) Downlink synchronization and an uplink timing advance between the terminal and each micro base station directly reuse a result between the terminal and the macro base station. In the LTE system, a minimum cyclic prefix (CP) length of a symbol is 4.69 μs. It is assumed that a coverage radius of the macro base station is 500 m, a coverage radius of the micro base station is 100 m, a maximum latency difference between the macro base station and the micro base station does not exceed 1.33 μs, and a maximum latency difference obtained when different terminals arrive at the micro base station does not exceed 0.33 μs. Therefore, impact caused by the latency difference can be eliminated by using a CP.

In this networking solution, to enable the network side to select a micro base station (for example: Transmission Point (TP)) or micro base station set that serves the terminal, the existing technical solution is as follows:

(1) The macro base station or a network controller of a HetNet network allocates, to a target terminal, a sending resource carrying an uplink measurement reference signal and another signal.

(2) The terminal sends a specified uplink measurement reference signal by using the specified resource.

(3) The network side such as a micro base station adjacent to the terminal in the HetNet performs measurement based on the uplink measurement reference signal, for example, measures reference signal received power (RSRP), to determine the micro base station/micro base station set that serves the terminal.

However, the foregoing solutions are not applicable to a scenario in which a micro base station is a high frequency base station, because a length of a high frequency symbol is of a microsecond level, for example, 1.25 μs, and a CP length is usually ⅕ of a symbol length, namely, 0.25 μs. Based on previous latency difference estimation, this CP length is not enough to eliminate impact caused by the latency difference between the macro base station and the micro base station and the TA latency difference of different terminals.

FIG. 1 describes the impact brought by the two types of latency differences:

Q1: Although time synchronization and uplink timing advance processes are completed between a terminal and a low frequency macro base station (an eNB in FIG. 1), in other words, a signal sent by a network side clock to the eNB and a signal sent by UE to the eNB in FIG. 1 are aligned in terms of time, when this result is reused on a micro base station, a random latency difference is caused when uplink transmission signals of different terminals (UE 1 and UE 2 in the figure) arrive at a micro base station (TP 1 in the figure). The latency difference damages time domain orthogonality of an uplink measurement reference signal and also interferes with a data part of the uplink measurement reference signal.

Q2: In addition, even for a single terminal (the UE 1 in the figure), when a result that the terminal is aligned with the macro base station in terms of time is reused on the micro base station (the TP 1 in the figure), a latency difference is caused between a low frequency macro base station and a high frequency micro base station because of different path propagation distances. This latency difference causes beam detection missing, and consequently a reference signal sent by using a specific beam cannot be completely received.

Therefore, in a HetNet hybrid networking scenario in which a micro base station is a high frequency base station and a macro base station is a low frequency base station, to resolve a prior-art problem that an uplink reference signal cannot be correctly transmitted because synchronization and a TA between a terminal and a low frequency macro base station cannot be reused between the terminal and a high frequency micro base station, how to design an uplink reference signal transmission solution to ensure uplink reference signal transmission accuracy is a problem to be resolved.

### SUMMARY

Embodiments of the present disclosure provide an uplink reference signal transmission method and apparatus, to implement complete uplink reference signal transmission, and improve data transmission accuracy.

Embodiments of the present disclosure are as follows:

According to a first aspect, an embodiment of the present disclosure provides an uplink reference signal transmission method, including:

obtaining, by a terminal, a time domain resource sending position of an uplink reference signal of the terminal on a high frequency link, where there is a guard interval at at least one end of the uplink reference signal; and

after arriving at the time domain resource sending position, switching, by the terminal, transmit beams in different time slices in M time slices to transmit the uplink reference signal, where the uplink reference signal includes uplink reference signals transmitted in the M different time slices, M is a positive integer greater than 1, and the reference signals formed in the M time slices may be continuously transmitted in terms of time, or may be classified into a plurality of intervals for distributed transmission.

In this embodiment, after determining the time domain resource sending position of the uplink reference signal of the terminal on the high frequency link, the terminal switches, based on a transmission format of the uplink reference signal, the transmit beams on the different time slices in the M time slices corresponding to the uplink reference signal, to transmit the uplink reference signal. Such an uplink reference signal transmission method is applicable to a HetNet networking scenario of a high frequency micro base station and a low frequency macro base station or a hybrid networking scenario of high frequency base stations. Complete transmission of the uplink reference signal can be implemented, and therefore data transmission accuracy is ensured.

With reference to the first aspect, in one embodiment, the guard interval is duration in which the terminal does not transmit a signal. Because terminals perform asynchronous transmission, the guard interval can prevent an uplink reference signal transmitted by a terminal from interfering with a signal transmitted by another terminal.

With reference to the first aspect, in one embodiment, the uplink reference signal includes a synchronization reference signal and/or an uplink measurement reference signal, and the uplink measurement reference signal includes a sounding reference signal. The synchronization reference signal is used to implement uplink synchronization between the terminal and a high frequency base station, and the measurement reference signal is used to measure channel state information between the terminal and the high frequency base station.

With reference to the first aspect, in one embodiment, a length of the guard interval is not less than a half of an uplink timing advance from the terminal to any high frequency base station.

With reference to the first aspect, in one embodiment, the terminal determines the time domain resource sending position of the uplink reference signal of the terminal on the high frequency link in the following three ways:

First: The terminal obtains a system clock of a low frequency base station based on a low frequency link, and determines a start point position, indicated by the system clock, of a timeslot of the low frequency link as the time domain resource sending position of the uplink reference signal of the terminal on the high frequency link.

Second: The terminal obtains a system clock of a low frequency base station and an uplink timing advance of the terminal on a low frequency link based on the low frequency link, and determines, as the time domain resource sending position of the uplink reference signal of the terminal on the high frequency link, a position that is the uplink timing advance after a start point, indicated by the system clock, of a timeslot of the low frequency link.

Third: The terminal receives indication information of the time domain resource sending position that is sent by a network side. In the HetNet networking scenario of a high frequency micro base station and a low frequency macro base station, the network side is a network controller of a HetNet network that includes a low frequency macro base station or a high frequency micro base station and a low frequency macro base station. In the hybrid networking scenario of high frequency base stations, the network side is a network controller in the hybrid network.

With reference to the first aspect, in one embodiment, the transmitting, by the terminal, the uplink reference signal includes:

generating a radio frame, where the radio frame includes at least one network-oriented measurement timeslot interval, and the network-oriented measurement timeslot interval includes the guard interval and a symbol used for uplink reference signal transmission; and

sending the radio frame to transmit the uplink reference signal.

In this radio frame structure, the guard interval may be placed at either end or both ends of the symbol used for uplink reference signal transmission.

According to a second aspect, an uplink reference signal transmission method is provided and includes:

determining, by a high frequency base station, N time slices that are used to receive an uplink reference signal transmitted by a terminal in a single time slice of the terminal, where N is a positive integer greater than 1; and

switching, by the high frequency base station, receive beams in different time slices in the N time slices to receive the uplink reference signal transmitted by the terminal in the single time slice of the terminal, where there is a guard interval at at least one end of the uplink reference signal.

In this way, the high frequency base station can completely receive the uplink reference signal sent by the terminal.

With reference to the second aspect, in one embodiment, the method further includes:

after traversing all receive beams in the single time slice of the terminal, continuing, by the high frequency base station, to switch a receive beam in a switching sequence of the receive beams to receive the reference signal transmitted by the terminal in the single time slice of the terminal.

In this embodiment, when the high frequency base station receives the uplink reference signal of the terminal, in addition to traversing the receive beams of the high frequency base station, the high frequency base station needs to perform switching at least one more time, continues to receive the uplink reference signal of the terminal, and can completely receive an uplink reference signal sent by using a specific transmit beam of the terminal, so as to overcome a beam detection missing problem.

According to a third aspect, an uplink reference signal transmission apparatus is provided and includes:

a determining unit, configured to determine a time domain resource sending position of an uplink reference signal of a terminal on a high frequency link, where there is a guard interval at at least one end of the uplink reference signal; and

a sending unit, configured to: after arriving at the time domain resource sending position, switch transmit beams in different time slices in M time slices to transmit the uplink reference signal, where the uplink reference signal includes uplink reference signals transmitted in the M different time slices, and M is a positive integer greater than 1.

With reference to the third aspect, in one embodiment, the guard interval is duration in which the terminal does not transmit a signal.

With reference to the third aspect, in one embodiment, the uplink reference signal includes a synchronization reference signal and/or an uplink measurement reference signal, and the uplink measurement reference signal includes a sounding reference signal.

With reference to the third aspect, in one embodiment, a length of the guard interval is not less than a half of an uplink timing advance from the terminal to any high frequency base station.

With reference to the third aspect, in one embodiment, when determining the time domain resource sending position of the uplink reference signal of the terminal on the high frequency link, the determining unit is configured to:

the determining a time domain resource sending position of an uplink reference signal of a terminal on a high frequency link includes: obtaining a system clock of a low frequency base station based on a low frequency link, and determining a start point position, indicated by the system clock, of a timeslot of the low frequency link as the time domain resource sending position of the uplink reference signal of the terminal on the high frequency link; or

obtain a system clock of a low frequency base station and an uplink timing advance of the terminal on a low frequency link based on the low frequency link, and determine, as the time domain resource sending position of the uplink reference signal of the terminal on the high frequency link, a position that is the uplink timing advance after a start point, indicated by the system clock, of a timeslot of the low frequency link; or

receive indication information of the time domain resource sending position that is sent by a network side.

With reference to the third aspect, in one embodiment, when transmitting the uplink reference signal, the sending unit is configured to:

generate a radio frame, where the radio frame includes at least one network-oriented measurement timeslot interval, and the network-oriented measurement timeslot interval includes the guard interval and a symbol used for uplink reference signal transmission; and

send the radio frame to transmit the uplink reference signal.

According to a fourth aspect, an uplink reference signal transmission apparatus is provided and includes:

a determining unit, configured to determine N time slices that are used to receive an uplink reference signal transmitted by a terminal in a single time slice of the terminal, where N is a positive integer greater than 1; and

a receiving unit, configured to switch receive beams in different time slices in the N time slices to receive the uplink reference signal transmitted by the terminal in the single time slice of the terminal, where there is a guard interval at at least one end of the uplink reference signal.

With reference to the fourth aspect, in one embodiment, the receiving unit is further configured to:

after traversing all receive beams in the single time slice of the terminal, continue to switch a receive beam in a switching sequence of the receive beams to receive the reference signal transmitted by the terminal in the single time slice of the terminal.

According to a fifth aspect, a terminal device is provided, and the terminal device has a function of implementing behavior of the terminal in any one of the foregoing aspects and embodiments. The function may be implemented by hardware, or may be implemented by hardware by executing corresponding software. The hardware or software includes one or more modules corresponding to the foregoing function.

In one embodiment, a structure of the terminal device includes a transceiver, a memory, and a processor. The memory is configured to store a group of programs, and the processor is configured to invoke the programs stored in the memory, to perform the method according to any one of the foregoing aspects and embodiments.

According to a sixth aspect, a base station is provided, and the base station has a function of implementing behavior of the high frequency base station in any one of the foregoing aspects and possible designs. The function may be implemented by hardware, or may be implemented by hardware by executing corresponding software. The hardware or software includes one or more modules corresponding to the foregoing function.

In one embodiment, a structure of the base station includes a transceiver, a memory, and a processor. The memory is configured to store a group of programs, and the processor is configured to invoke the programs stored in the memory, to perform the method according to any one of the foregoing aspects and embodiments.

The uplink reference signal transmission solution provided in the present disclosure can implement complete transmission of uplink reference signals in different networking scenarios, for example, a HetNet networking scenario of a high frequency micro base station and a low frequency macro base station or a hybrid networking scenario of a plurality of high frequency micro base stations or high frequency macro base stations, so as to improve data transmission accuracy between a terminal and a high frequency base station.

### BRIEF DESCRIPTION OF DRAWINGS

FIG. 1 is a schematic diagram of impact caused by a latency difference between macro and micro base stations in a HetNet scenario;

FIG. 2 is a schematic diagram of an application scenario according to the present disclosure;

FIG. 3 is a flowchart of an uplink reference signal transmission method according to an embodiment of the present disclosure;

FIG. 4 is a schematic diagram of a guard interval placement position according to an embodiment of the present disclosure;

FIG. 5 is a schematic diagram of uplink reference signal transmission between a terminal and a high frequency micro base station according to an embodiment of the present disclosure;

FIG. 6A, FIG. 6B, and FIG. 6C are schematic diagrams of orthogonal processing performed by a terminal on an uplink reference signal according to an embodiment of the present disclosure;

FIG. 7 is a schematic diagram of another application scenario according to the present disclosure;

FIG. 8 is a schematic diagram of a frame structure applied to a communications system of hybrid networking of a high frequency micro base station and a low frequency macro base station according to Embodiment 1 of the present disclosure;

FIG. 9A is a schematic diagram of placing an uplink reference signal on a time domain resource according to Embodiment 2 of the present disclosure;

FIG. 9B is a schematic diagram of a frame structure applied to a communications system of hybrid networking of a high frequency micro base station and a low frequency macro base station according to Embodiment 2 of the present disclosure;

FIG. 10 is a schematic flowchart of an uplink synchronization reference signal transmission method according to Embodiment 3 of the present disclosure;

FIG. 11 is a schematic flowchart of an uplink measurement reference signal transmission method according to Embodiment 4 of the present disclosure;

FIG. 12 is a schematic flowchart of an uplink synchronization reference signal transmission method according to Embodiment 5 of the present disclosure;

FIG. 13 is a schematic flowchart of an uplink measurement reference signal transmission method according to Embodiment 6 of the present disclosure;

FIG. 14 is a structural diagram of an uplink reference signal transmission apparatus according to an embodiment of the present disclosure;

FIG. 15 is a structural diagram of a terminal device according to an embodiment of the present disclosure;

FIG. 16 is a structural diagram of an uplink reference signal transmission apparatus according to an embodiment of the present disclosure; and

FIG. 17 is a structural diagram of a network side device according to an embodiment of the present disclosure.

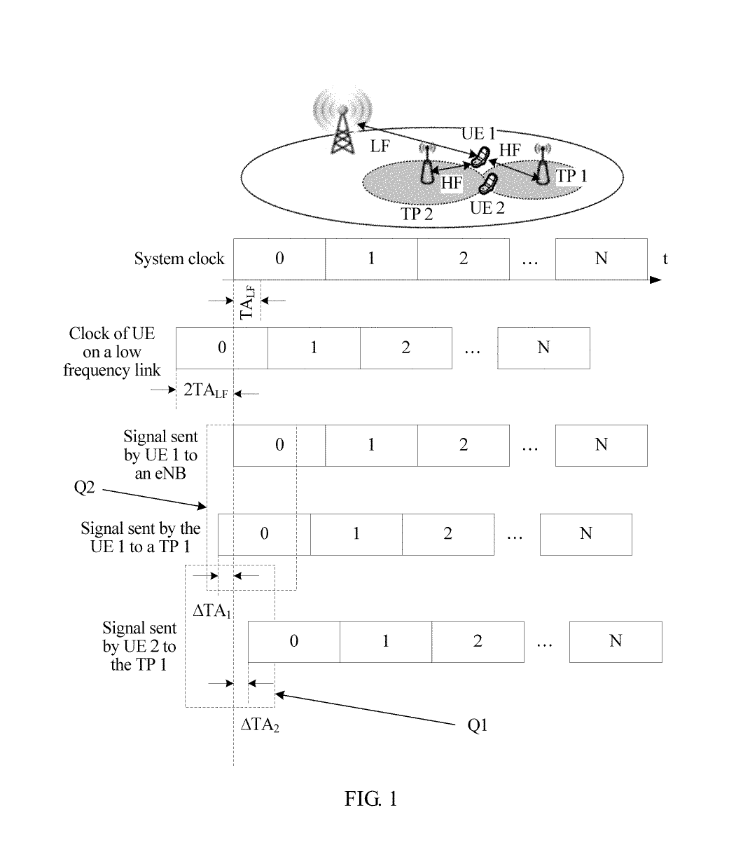

### DESCRIPTION OF EMBODIMENTS

The following clearly describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

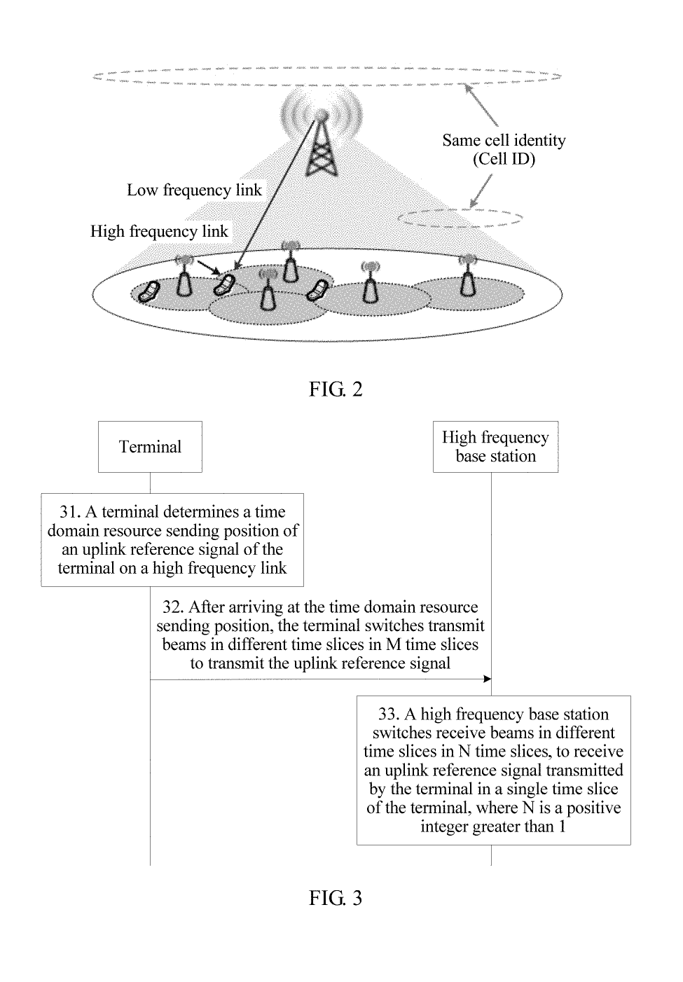

As shown in FIG. 2, FIG. 2 is a schematic diagram of an application scenario according to an embodiment of the present disclosure. The application scenario specifically includes a terminal, a low frequency macro base station, and at least one high frequency micro base station. In one embodiment, there may be a low frequency micro base station in this scenario. The high frequency micro base station relies on the low frequency macro base station to implement some transmission functions. The terminal is equipped with both a low frequency transceiver and a high frequency transceiver. The low frequency transceiver performs data communication with the low frequency macro base station by using a low frequency link, and the high frequency transceiver performs data communication with the high frequency micro base station by using a high frequency link.

Based on the schematic diagram of the application scenario shown in FIG. 2, an embodiment of the present disclosure provides an uplink reference signal transmission method. As shown in FIG. 3, a specific procedure includes the following operations.

Operation 31: A terminal determines a time domain resource sending position of an uplink reference signal of the terminal on a high frequency link, where there is a guard interval at at least one end of the uplink reference signal.

The high frequency link is a communication link between the terminal and a high frequency base station, and the high frequency link is used for high frequency band transmission. Usually, a frequency band greater than 6 GHz is referred to as a high frequency band. Certainly, the high frequency band may alternatively be set based on a specific networking environment of the terminal.

In one embodiment, the terminal may determine the time domain resource sending position of the uplink reference signal of the terminal on the high frequency link in the following three ways:

First: The terminal obtains a system clock of a low frequency base station based on a low frequency link, and determines a start point position, indicated by the system clock, of a timeslot of the low frequency link as the time domain resource sending position of the uplink reference signal of the terminal on the high frequency link.

Second: The terminal obtains a system clock of a low frequency base station and an uplink timing advance of the terminal on a low frequency link based on the low frequency link, and determines, as the time domain resource sending position of the uplink reference signal of the terminal on the high frequency link, a position that is the uplink timing advance after a start point, indicated by the system clock, of a timeslot of the low frequency link.

Third: The terminal receives indication information of the time domain resource sending position that is sent by a network side.

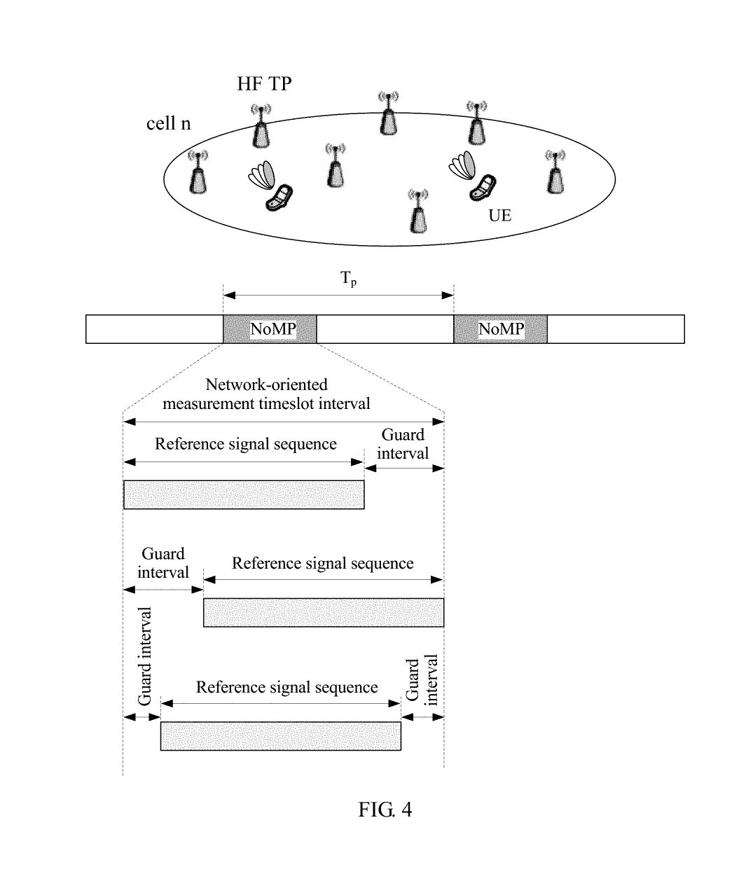

The uplink reference signal is periodically and intensively transmitted in a network-oriented measurement timeslot (NoMT) interval. In one embodiment, the NoMT is placed in a radio frame. In one embodiment, one radio frame may include one or more NoMTs, or one radio frame every a plurality of radio frames includes the NoMT. The NoMT includes an uplink reference signal and a guard interval, and the uplink reference signal and the guard interval are placed in three manners. As shown in FIG. 4, the guard interval may be placed at either end of the reference signal, or may be placed at both ends of the reference signal, and the terminal does not transmit any signal within a time period of the guard interval.

It should be noted that a length of the guard interval is determined based on a specific deployment scenario of a macro base station and a micro base station in a HetNet network. The length of the guard interval is not less than ½ of an uplink TA from the terminal to any high frequency micro base station. In other words, L≥max|TAᵢ/2|, where L is the length of the guard interval, and TAᵢ is the uplink TA from the terminal to any high frequency micro base station. The uplink TA from the terminal to any high frequency micro base station is obtained through estimation by using an uplink TA from the terminal to a low frequency macro base station, position information of the high frequency micro base station, and position information of the low frequency macro base station. Alternatively, the guard interval and the length of the guard interval may be not specified. That there is the guard interval at the at least one end of the reference signal can be implicitly determined by using an NoMT interval length and a reference signal length, so as to determine the length of the guard interval.

The uplink reference signal includes a synchronization reference signal and/or an uplink measurement reference signal. The synchronization reference signal is used to implement uplink synchronization between the terminal and the high frequency base station, and the uplink measurement reference signal is used to measure channel state information between the terminal and the high frequency base station, for example, detecting signal strength at a receive end. The uplink measurement reference signal includes a sounding reference signal (SRS) sent by the terminal. The high frequency base station may implement uplink channel estimation by measuring the SRS, and allocate uplink resources based on the estimation. It can be learned that the SRS is extremely important for uplink channel estimation to dynamically allocate uplink resources. In addition, the SRS may also be used for operations such as uplink timing of the terminal and reciprocity-assisted downlink beamforming, and is also extremely important for these operations.

Operation 32: After arriving at the time domain resource sending position, the terminal switches transmit beams in different time slices in M time slices to transmit the uplink reference signal, where the uplink reference signal includes uplink reference signals transmitted in the M different time slices, and M is a positive integer greater than 1.

A corresponding time length for transmitting the uplink reference signal is divided into M time slices, and lengths of the time slices are the same, and may be one symbol, or may be a plurality of (≥2) symbols. A quantity of time slices corresponding to the uplink reference signal may be specified in advance, or may be specifically determined based on a quantity of transmit beams of the terminal. The quantity of transmit beams of the terminal is not less than the quantity M of time slices corresponding to the uplink reference signal.

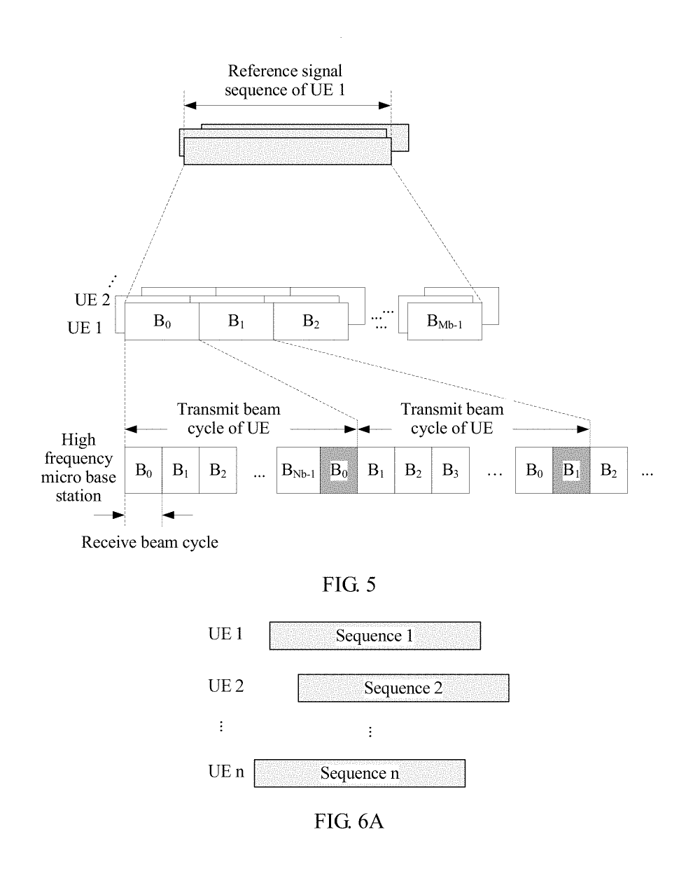

FIG. 5 is a schematic diagram of uplink reference signal transmission between a terminal and a high frequency micro base station. On a terminal side, the terminal sends an uplink reference signal in each time slice by using a different transmit beam. For example, the terminal sends a reference signal in a time slice B₀ by using a transmit beam #0, and sends a reference signal in a time slice B₁ by using a transmit beam #1. In one embodiment, the terminal may send the uplink reference signal in the following two manners:

A first manner is a centralized sending manner. In this case, the quantity M of time slices corresponding to the uplink reference signal of the terminal is not less than a minimum quantity of transmit beams required by the terminal to transmit the uplink reference signal in a specific directional area. For example, if the terminal needs to cover an area from 0° to 60°, and a beam width is 10°, at least six transmit beams are required, and a value of M needs to be greater than or equal to 6.

A second manner is a distributed sending manner. In this case, the quantity M of time slices corresponding to the uplink reference signal of the terminal is less than a minimum quantity of transmit beams required by the terminal to transmit the uplink reference signal in a specific directional area, but the minimum quantity of transmit beams required by the terminal to transmit the uplink reference signal in the specific directional area may be reached by using a plurality of reference signals.

In addition, the terminal needs to select a different transmit beam in each time slice to send at least one uplink reference signal in a synchronization reference signal and a measurement reference signal, and In one embodiment, further needs to send an identity of the terminal.

Operation 33: A high frequency base station switches receive beams in different time slices in N time slices, to receive an uplink reference signal transmitted by the terminal in a single time slice of the terminal, where N is a positive integer greater than 1.

As shown in FIG. 5, on a high frequency micro base station side, in duration of the single time slice of the terminal, the high frequency micro base station further divides the single time slice into N tiny time slices, and receives, in these tiny time slices by using different directional receive beams, the uplink reference signal sent by the terminal.

A length of the tiny time slice described above may be one symbol, or may be a plurality of (≥2) symbols.

It should be noted that, if a total quantity of receive beams of the high frequency micro base station is N_{b}, in the duration of the single time slice of the terminal, the high frequency micro base station needs to divide the single time slice into (N_{b}+n) tiny time slices, where N_{b}+n=N, and cyclically receives, in the (N_{b}+n) tiny time slices by using the receive beams, the uplink reference signal sent by the terminal. Herein, a value of n is usually 1. As shown in FIG. 5, after the high frequency micro base station traverses the receive beams of the high frequency micro base station, and a beam used for one extra directional reception is a beam used in a start time slice. As shown in FIG. 5, a start receive beam is B₀, and a receive beam used for one extra reception is still B₀.

The value of n may alternatively be 2 or a positive integer greater than 2. A specific value is related to a maximum latency difference between high and low frequency base stations and transmission duration of a single reference signal. For example, if the maximum latency difference between high and low frequency base stations is 1.33 μs, and the transmission duration of a single reference signal is one symbol period whose length is 0.64 μs, n=┌Maximum latency difference between high and low frequency base stations/Transmission duration of a single reference signal┐=3.

After traversing all receive beams in the single time slice of the terminal, the high frequency base station continues to switch a receive beam in a switching sequence of the receive beams to receive the reference signal transmitted by the terminal in the single time slice of the terminal.

The uplink reference signal at the NoMT interval is divided into time slices on the terminal side. Each time slice includes symbols, and a reference signal used for synchronization or measurement is carried by these symbols. The following orthogonal design techniques may be used for resource allocation methods for uplink reference signals of different terminals.

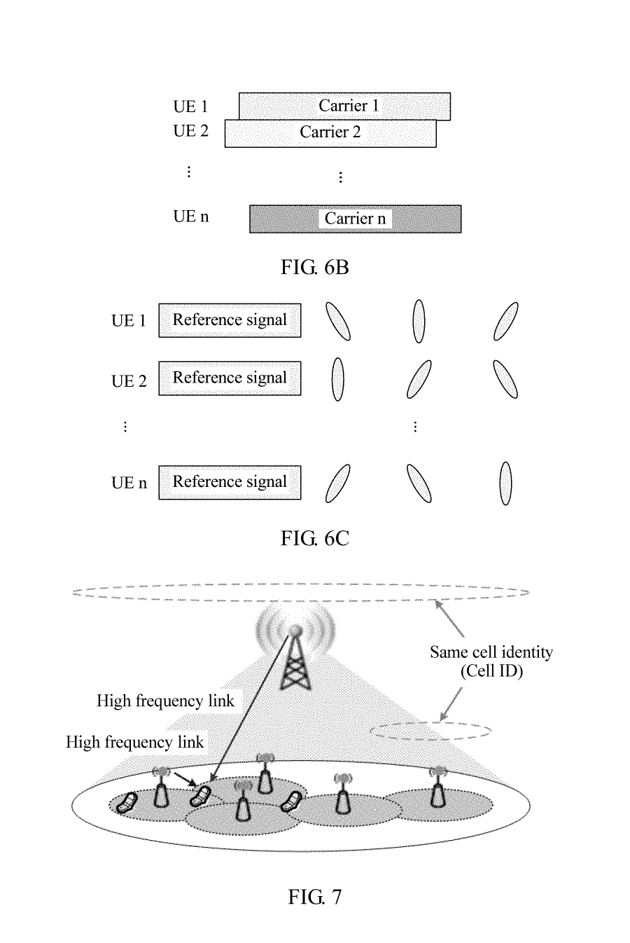

Technique 1: Code division orthogonal manner. As shown in FIG. 6A, uplink reference signals of different terminals are encoded by using different orthogonal sequences with fine cross-correlation features, so that a receive end can separate a target reference signal from time-frequency hybrid signals.

Technique 2: Frequency division orthogonal manner. As shown in FIG. 6B, for a multicarrier system, uplink reference signals of different terminals may be carried by different subcarriers of a symbol, so that interference caused by time domain misalignment is avoided through frequency division.

Technique 3: Wavelength division orthogonal manner. As shown in FIG. 6C, because the high frequency micro base station uses a directional beam, different terminals may send respective reference signals at a same moment by using beams corresponding to different directional beams, and this method is also referred to as beam spatial multiplexing.

Technique 4: Combination of any two or three of the foregoing three manners. When there are a relatively large quantity of terminals, any two or three of the foregoing three manners may be combined. For example, the terminals are classified into groups, one orthogonal multiplexing manner is used between groups, and another orthogonal multiplexing manner is used within a group.

It should be noted that the uplink reference signal transmission method shown in FIG. 3 is also applicable to a hybrid networking application scenario of a plurality of high frequency base stations shown in FIG. 7. The application scenario specifically includes a terminal and a plurality of high frequency micro base stations. In the hybrid networking scenario of a plurality of high frequency base stations, the high frequency base station may be a high frequency micro base station, or may be a high frequency macro base station.

### Embodiment 1

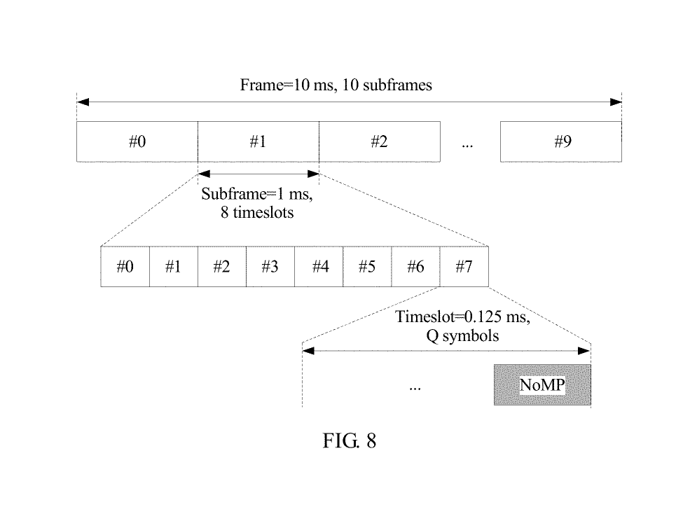

As shown in FIG. 8, Embodiment 1 provides a frame structure applied to a communications system of hybrid networking of a high frequency micro base station and a low frequency macro base station shown in FIG. 2 or hybrid networking of a plurality of high frequency base stations shown in FIG. 7. In a hybrid networking scenario of a plurality of high frequency base stations, the high frequency base station may be a high frequency micro base station, or may be a high frequency macro base station.

In FIG. 8, a frame length of one radio frame is 10 milliseconds. The radio frame includes 10 radio subframes with a frame length of 1 millisecond, and one radio subframe is further divided into eight timeslots with a length of 0.125 millisecond. Each timeslot includes Q symbols, and the symbol may be a single carrier symbol, or may be a multicarrier symbol such as an OFDM symbol. A typical value of Q may be set to 7n, where n is a positive integer. These timeslots are further classified into uplink timeslots and downlink timeslots.

An NoMT in the present disclosure is placed in an uplink timeslot of a subframe, and may be placed at a header of the uplink timeslot or at a tail of the uplink timeslot. For example, in FIG. 8, the NoMT is placed at a tail of an eighth timeslot (the timeslot is an uplink timeslot) of a second subframe.

### Embodiment 2

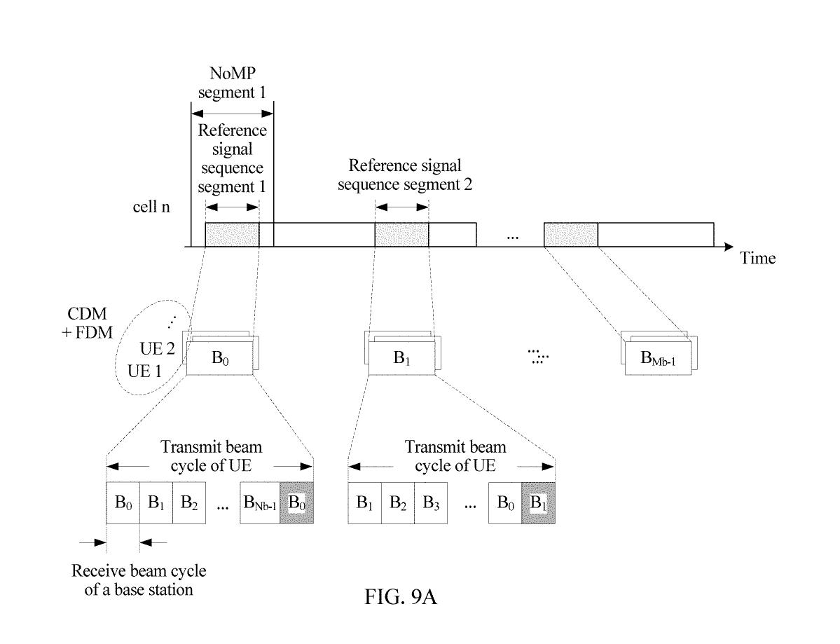

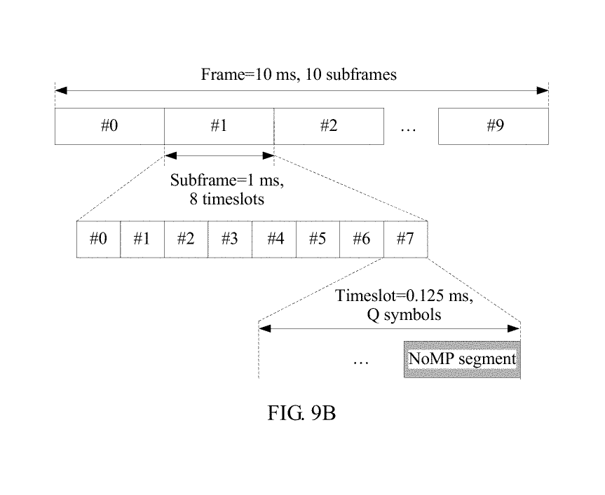

As shown in FIG. 9A and FIG. 9B, Embodiment 2 provides another frame structure applied to a communications system of hybrid networking of a high frequency micro base station and a low frequency macro base station shown in FIG. 2 or hybrid networking of a plurality of high frequency base stations shown in FIG. 7. In a hybrid networking scenario of a plurality of high frequency base stations, the high frequency base station may be a high frequency micro base station, or may be a high frequency macro base station.

As shown in FIG. 9A, different from Embodiment 1, because uplink reference signals are not contiguous on time domain resources, NoMT intervals used for transmitting the uplink reference signals are also in a distributed manner, and the NoMT intervals are divided into NoMT segments.

In FIG. 9B, a frame length of one radio frame is 10 milliseconds. The radio frame includes 10 radio subframes with a frame length of 1 millisecond, and one radio subframe is further divided into eight timeslots with a length of 0.125 millisecond. Each timeslot includes Q symbols, and the symbol may be a single carrier symbol, or may be a multicarrier symbol such as an OFDM symbol. A typical value of Q may be set to 7n, where n is a positive integer. These timeslots are further classified into uplink timeslots and downlink timeslots.

The NoMT segment in the present disclosure is placed in an uplink timeslot of a subframe, and may be placed at a header of the uplink timeslot or at a tail of the uplink timeslot. For example, in FIG. 9B, the NoMT segment is placed at a tail of an eighth timeslot (the timeslot is an uplink timeslot) of a second subframe.

### Embodiment 3

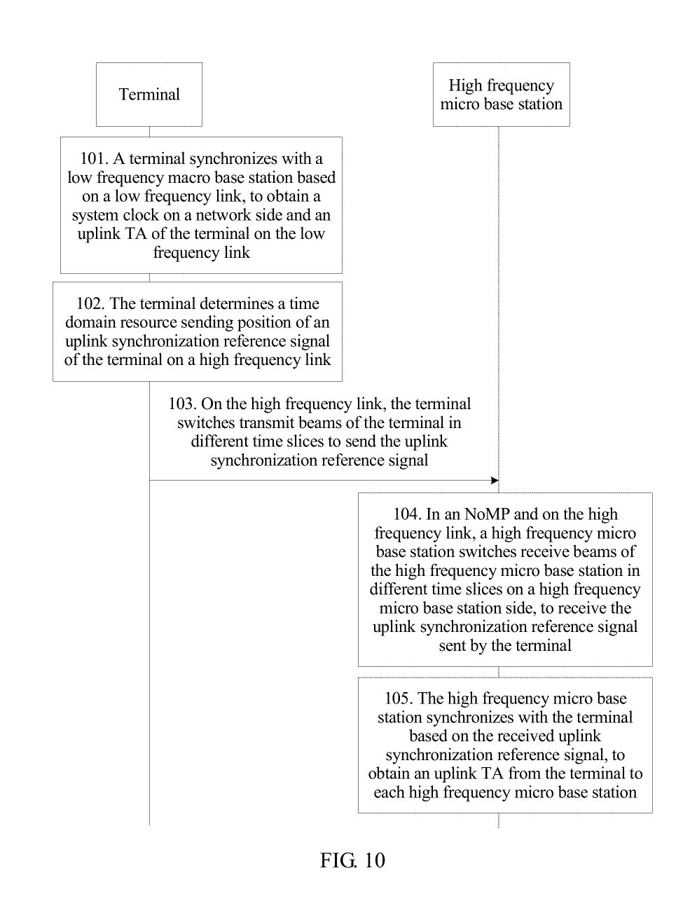

Based on the frame structures provided in Embodiment 1 and Embodiment 2, Embodiment 3 provides an uplink synchronization reference signal transmission method, and the method is applied to a network deployment scenario shown in FIG. 2. As shown in FIG. 10, specific operations are as follows.

Operation 101: A terminal synchronizes with a low frequency macro base station based on a low frequency link, to obtain a system clock on a network side and an uplink TA of the terminal on the low frequency link.

Operation 102: The terminal determines a time domain resource sending position of an uplink synchronization reference signal of the terminal on a high frequency link.

In a method for determining the time domain resource sending position, the system clock obtained on the low frequency link and/or an uplink TA value obtained by the terminal on the low frequency link may be used, and a start point of a specific timeslot of the low frequency link may be used as the time domain resource sending position of the uplink reference signal on the high frequency link, namely, a time domain position of a start point of an NoMT.

Operation 103: Based on the frame structure provided in Embodiment 1 or Embodiment 2, on the high frequency link, the terminal switches transmit beams of the terminal in different time slices to send the uplink synchronization reference signal, and may also send an identity of the terminal.

Operation 104: In an NoMT and on the high frequency link, each high frequency micro base station on the network side switches receive beams of the high frequency micro base station in different time slices on a high frequency micro base station side, to receive the uplink synchronization reference signal sent by the terminal, where a length of the time slice on the high frequency micro base station side is less than a length of a time slice on a terminal side. After the high frequency micro base station traverses the receive beams of the high frequency micro base station but there is still a remaining time slice, the high frequency micro base station continues to traverse the receive beams of the high frequency micro base station in an original beam switching sequence, to receive the uplink synchronization reference signal sent by the terminal. After the terminal switches a transmit beam, the high frequency micro base station continues to traverse the receive beams of the high frequency micro base station without changing the receive beam sequence, to detect and receive the uplink synchronization reference signal sent by the terminal.

Operation 105: Each high frequency micro base station on the network side synchronizes with the terminal based on the received uplink synchronization reference signal, to obtain an uplink TA from the terminal to each high frequency micro base station.

### Embodiment 4

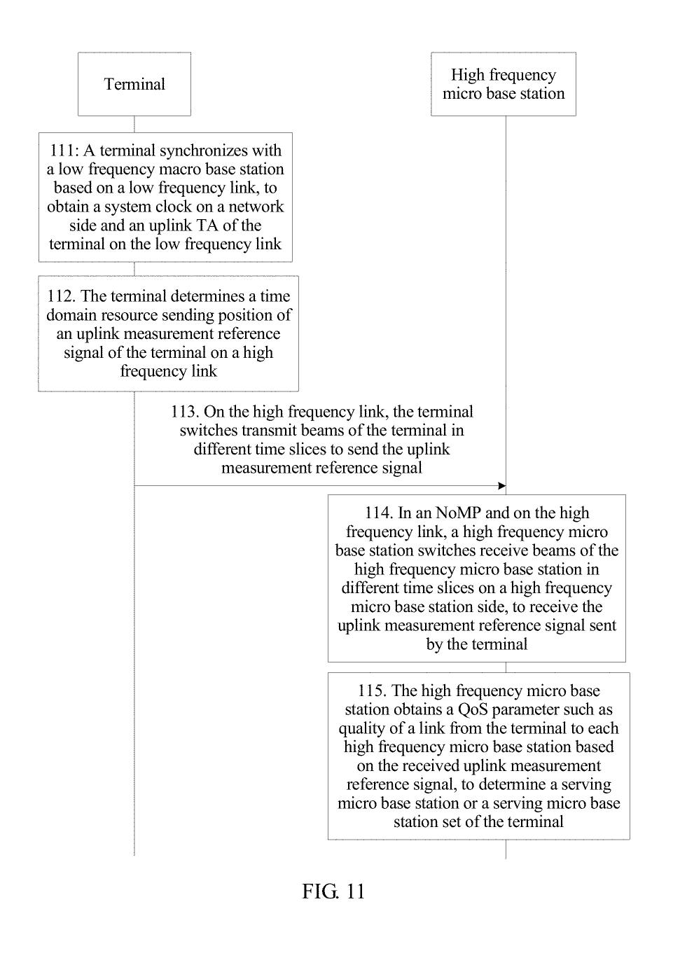

Based on the frame structures provided in Embodiment 1 and Embodiment 2, Embodiment 4 provides an uplink measurement reference signal transmission method, and the method is applied to a network deployment scenario shown in FIG. 2. As shown in FIG. 11, specific operations are as follows.

Operation 111: A terminal synchronizes with a low frequency macro base station based on a low frequency link, to obtain a system clock on a network side and an uplink TA of the terminal on the low frequency link.

Operation 112: The terminal determines a time domain resource sending position of an uplink measurement reference signal of the terminal on a high frequency link.

In a method for determining the time domain resource sending position, the system clock obtained on the low frequency link and/or an uplink TA value obtained by the terminal on the low frequency link may be used, and a start point of a specific timeslot of the low frequency link may be used as the time domain resource sending position of the uplink reference signal on the high frequency link, namely, a time domain position of a start point of an NoMT.

Operation 113: Based on the frame structure provided in Embodiment 1 or Embodiment 2, on the high frequency link, the terminal switches transmit beams of the terminal in different time slices to send the uplink measurement reference signal, and may also send an identity of the terminal.

Operation 114: In an NoMT and on the high frequency link, each high frequency micro base station on the network side switches receive beams of the high frequency micro base station in different time slices on a high frequency micro base station side, to receive the uplink measurement reference signal sent by the terminal, where a length of the time slice on the high frequency micro base station side is less than a length of a time slice on a terminal side. After the high frequency micro base station traverses the receive beams of the high frequency micro base station but there is still a remaining time slice, the high frequency micro base station continues to traverse the receive beams of the high frequency micro base station in an original beam switching sequence, to receive the uplink measurement reference signal sent by the terminal. After the terminal switches a transmit beam, the high frequency micro base station continues to traverse the receive beams of the high frequency micro base station without changing the receive beam sequence, to detect and receive the uplink measurement reference signal sent by the terminal.

Operation 115: Each high frequency micro base station on the network side obtains a QoS parameter such as quality of a link from the terminal to each high frequency micro base station based on the received uplink measurement reference signal, to determine a serving micro base station or a serving micro base station set of the terminal.

It should be noted that main operations in Embodiment 4 are the same as those in Embodiment 3. A main difference is that a reference signal carried by an uplink signal of the terminal is a measurement reference signal instead of a synchronization reference signal. During final system design, the two types of reference signals may be combined. In other words, a group of reference signals are used for both synchronization and measurement.

### Embodiment 5

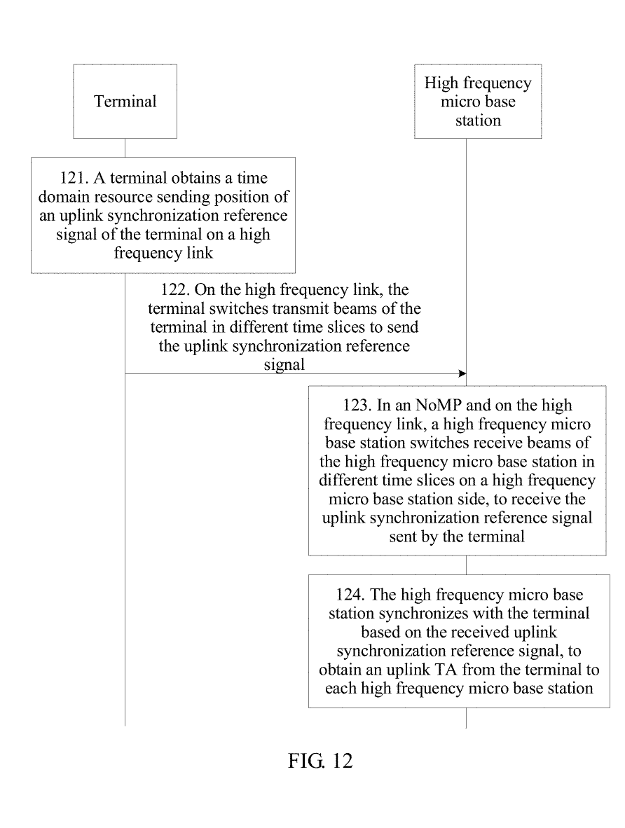

Based on the schematic diagram of the application scenario shown in FIG. 7, an embodiment of the present disclosure provides an uplink synchronization reference signal transmission method. As shown in FIG. 12, a specific procedure includes the following operations.

Operation 121: A terminal obtains a time domain resource sending position of an uplink synchronization reference signal of the terminal on a high frequency link. In one embodiment, a method for obtaining the time domain resource sending position of the uplink synchronization reference signal may be: A neighboring high frequency micro base station notifies, through broadcasting, the terminal of a system clock used by the high frequency micro base station, and the terminal determines the time domain resource sending position of the uplink reference signal of the terminal on the high frequency link through calculation based on the system clock, namely, a time domain position of a start point of an NoMT.

Operation 122: Based on the frame structure provided in Embodiment 1 or Embodiment 2, on the high frequency link, the terminal switches transmit beams of the terminal in different time slices to send the uplink synchronization reference signal, and may also send an identity of the terminal.

Operation 123: In an NoMT and on the high frequency link, each high frequency micro base station on a network side switches receive beams of the high frequency micro base station in different time slices on a high frequency micro base station side, to receive the uplink synchronization reference signal sent by the terminal.

A length of the time slice on the high frequency micro base station side is less than a length of a time slice on a terminal side. After the high frequency micro base station traverses the receive beams of the high frequency micro base station but there is still a remaining time slice, the high frequency micro base station continues to traverse the receive beams of the high frequency micro base station in an original beam switching sequence, to receive the uplink synchronization reference signal sent by the terminal. After the terminal switches a transmit beam, the high frequency micro base station continues to traverse the receive beams of the high frequency micro base station without changing the receive beam sequence, to detect and receive the uplink synchronization reference signal sent by the terminal.

Operation 124: Each high frequency micro base station on the network side synchronizes with the terminal based on the received uplink synchronization reference signal, to obtain an uplink TA from the terminal to each high frequency micro base station.

### Embodiment 6

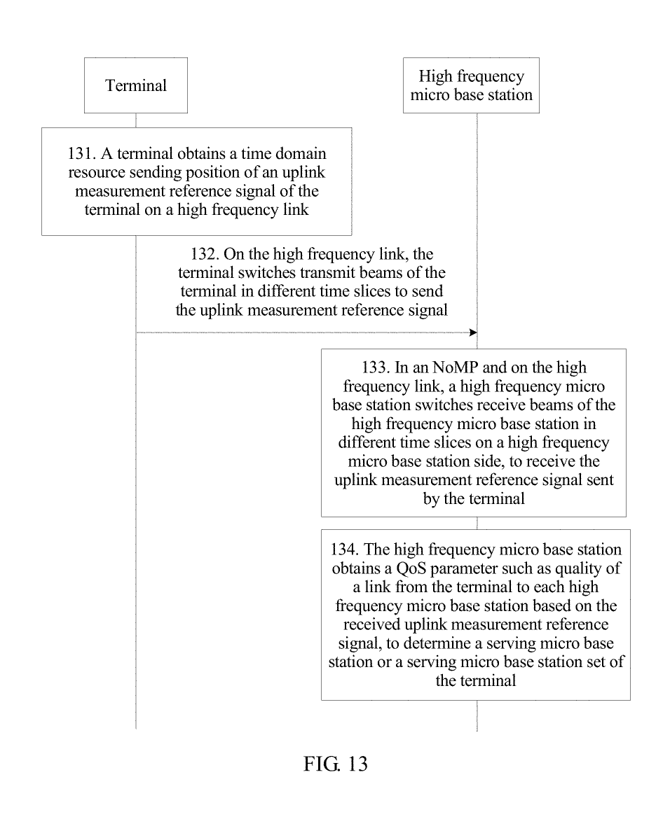

Based on the schematic diagram of the application scenario shown in FIG. 7, an embodiment of the present disclosure provides an uplink measurement reference signal transmission method. As shown in FIG. 13, a specific procedure includes the following operations.

Operation 131: A terminal obtains a time domain resource sending position of an uplink measurement reference signal of the terminal on a high frequency link. In one embodiment, a method for obtaining the time domain resource sending position of the uplink measurement reference signal may be: A neighboring high frequency micro base station notifies, through broadcasting, the terminal of a system clock used by the high frequency micro base station, and the terminal determines the time domain resource sending position of the uplink reference signal of the terminal on the high frequency link through calculation based on the system clock, namely, a time domain position of a start point of an NoMT.

Operation 132: Based on the frame structure provided in Embodiment 1 or Embodiment 2, on the high frequency link, the terminal switches transmit beams of the terminal in different time slices to send the uplink measurement reference signal, and may also send an identity of the terminal.

Operation 133: In an NoMT and on the high frequency link, each high frequency micro base station on a network side switches receive beams of the high frequency micro base station in different time slices on a high frequency micro base station side, to receive the uplink measurement reference signal sent by the terminal.

A length of the time slice on the high frequency micro base station side is less than a length of a time slice on a terminal side. After the high frequency micro base station traverses the receive beams of the high frequency micro base station but there is still a remaining time slice, the high frequency micro base station continues to traverse the receive beams of the high frequency micro base station in an original beam switching sequence, to receive the uplink measurement reference signal sent by the terminal. After the terminal switches a transmit beam, the high frequency micro base station continues to traverse the receive beams of the high frequency micro base station without changing the receive beam sequence, to detect and receive the uplink synchronization reference signal sent by the terminal.

Operation 134: Each high frequency micro base station on the network side obtains a QoS parameter such as quality of a link from the terminal to each high frequency micro base station based on the received uplink measurement reference signal, to determine a serving micro base station or a serving micro base station set of the terminal.

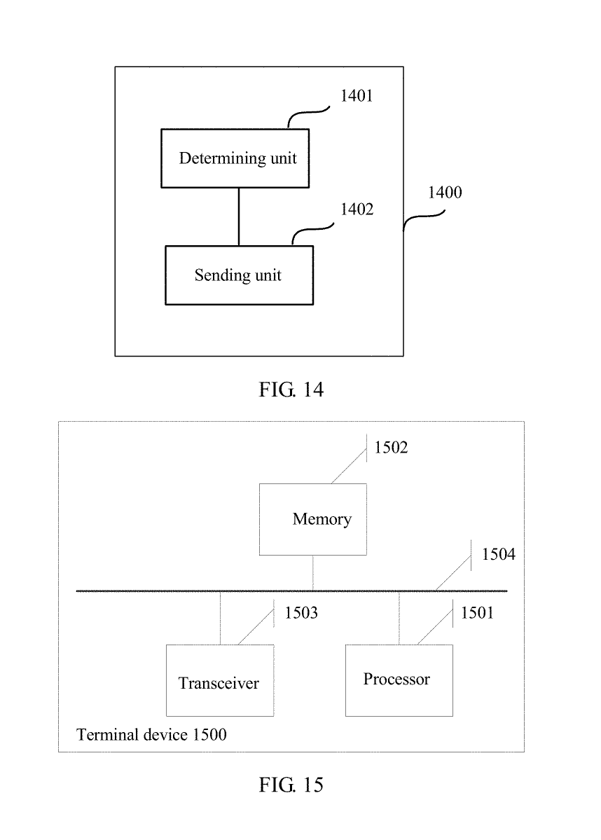

Based on the foregoing embodiments, as shown in FIG. 14, FIG. 14 is a schematic structural diagram of an uplink reference signal transmission apparatus 1400 according to an embodiment of the present disclosure. The apparatus 1400 is applied to a terminal in a HetNet scenario in which a high frequency base station is a micro base station and a low frequency base station is a macro base station or a terminal in a networking scenario of only high frequency base stations, and may be configured to perform an execution process of the terminal in the foregoing method embodiments. The apparatus 1400 includes a determining unit 1401 and a sending unit 1402.

The determining unit 1401 is configured to determine a time domain resource sending position of an uplink reference signal of a terminal on a high frequency link, where there is a guard interval at at least one end of the uplink reference signal.

The sending unit 1402 is configured to: after arriving at the time domain resource sending position, switch transmit beams in different time slices in M time slices to transmit the uplink reference signal, where the uplink reference signal includes uplink reference signals transmitted in the M different time slices, and M is a positive integer greater than 1.

In one embodiment, the guard interval is duration in which the terminal does not transmit a signal.

In one embodiment, the uplink reference signal includes a synchronization reference signal and/or an uplink measurement reference signal, and the uplink measurement reference signal includes a sounding reference signal.

In one embodiment, a length of the guard interval is not less than a half of an uplink timing advance from the terminal to any high frequency base station.

In one embodiment, when determining the time domain resource sending position of the uplink reference signal of the terminal on the high frequency link, the determining unit 1401 is configured to:

obtain a system clock of a low frequency base station based on a low frequency link, and determine a start point position, indicated by the system clock, of a timeslot of the low frequency link as the time domain resource sending position of the uplink reference signal of the terminal on the high frequency link; or

obtain a system clock of a low frequency base station and an uplink timing advance of the terminal on a low frequency link based on the low frequency link, and determine, as the time domain resource sending position of the uplink reference signal of the terminal on the high frequency link, a position that is the uplink timing advance after a start point, indicated by the system clock, of a timeslot of the low frequency link; or

receive indication information of the time domain resource sending position that is sent by a network side.

In one embodiment, when transmitting the uplink reference signal, the sending unit 1402 is configured to:

generate a radio frame, where the radio frame includes at least one network-oriented measurement timeslot interval, and the network-oriented measurement timeslot interval includes the guard interval and a symbol used for uplink reference signal transmission; and

send the radio frame to transmit the uplink reference signal.

The apparatus 1400 in this embodiment of the present disclosure may be an independent component, or may be integrated into another component. For example, the apparatus 1400 provided in this embodiment of the present disclosure may be a terminal in an existing communications network, or may be a component integrated into a terminal.

It should be noted that, for function implementation and an interaction manner of the units of the apparatus 1400 in this embodiment of the present disclosure, further refer to descriptions in a related method embodiment. Details are not described herein again.

In addition, each foregoing “unit” may be implemented by using an application-specific integrated circuit (ASIC), a processor and a memory that execute one or more software or firmware programs, an integrated logic circuit, and/or another device that can provide the foregoing functions.

Based on a same concept, as shown in FIG. 15, FIG. 15 is a schematic structural diagram of a terminal device 1500 according to an embodiment of the present disclosure. The terminal device 1500 may be configured to perform an execution process of the terminal in the foregoing method embodiments. The terminal device 1500 may be a wireless terminal. The wireless terminal may be a device that provides voice and/or data connectivity for a user, a handheld device with a wireless connection function, or another processing device connected to a wireless modem. The wireless terminal may communicate with one or more core networks by using a radio access network (RAN). The wireless terminal may be a mobile terminal, such as a mobile phone (or referred to as a “cellular” phone) or a computer with a mobile terminal. For example, the wireless terminal may be a portable, pocket-sized, handheld, or a computer built-in mobile apparatus, or an in-vehicle mobile apparatus, which exchanges voice and/or data with the radio access network. For example, the wireless terminal may be a device such as a personal communications service (PCS) phone, a cordless telephone set, a Session Initiation Protocol (SIP) phone, a wireless local loop (WLL) station, or a personal digital assistant (PDA). The wireless terminal may also be referred to as a subscriber unit, a subscriber station, a mobile station, a mobile station, a remote station, an access point (AP), a remote terminal, an access terminal, a user terminal, a user agent, a user device, or user equipment. The present disclosure imposes no limitation thereto. For example, the terminal further includes a wired-access terminal with a multi-carrier feature.

Referring to FIG. 15, the terminal device 1500 includes a processor 1501, a memory 1502, and a transceiver 1503.

The processor 1501, the memory 1502, and the transceiver 1503 are connected to each other by using a bus 1504.

The transceiver 1503 may implement a function by using a receiver and a transmitter, and the transceiver 1503 may be a wired transceiver, a wireless transceiver, or a combination thereof. The wired transceiver may be, for example, an Ethernet interface. The Ethernet interface may be an optical interface, an electrical interface, or a combination thereof. The wireless transceiver may be, for example, a wireless local area network transceiver, a cellular network transceiver, or a combination thereof.

The processor 1501 is configured to invoke a program stored in the memory 1502 to perform the following operations: determining a time domain resource sending position of an uplink reference signal of the terminal device on a high frequency link, where there is a guard interval at at least one end of the uplink reference signal; and after the terminal device arrives at the time domain resource sending position, switching transmit beams in different time slices in M time slices to transmit the uplink reference signal, where the uplink reference signal includes uplink reference signals transmitted in the M different time slices, and M is a positive integer greater than 1.

The processor 1501 may be a central processing unit (CPU), a general-purpose processor, a digital signal processor (DSP), an application-specific integrated circuit (ASIC), a field programmable gate array (FPGA) or another programmable logic device, a transistor logic device, a hardware component, or any combination thereof. The processor may implement or execute various example logical blocks, modules, and circuits described with reference to content of the terminal disclosed in the present disclosure. The processor may also be a combination for implementing computing functions, for example, a combination of one or more microprocessors and a combination of a DSP and a microprocessor.

The memory 1502 may include a volatile memory such as a RAM; or the memory 1502 may include a nonvolatile memory such as a ROM, a flash memory, an HDD, or an SSD; or the memory 1502 may include a combination of the foregoing memories. In one embodiment, the memory 1502 stores voice indication information corresponding to a network frequency channel number.

The memory 1502 may be configured to store a message, data, and a storage instruction that are received by the transceiver 1503.

The processor 1501 invokes the instruction stored in the memory 1502 to perform method operations in the method embodiments of the present disclosure, so as to implement the technical solutions in the method embodiments of the present disclosure.

In FIG. 15, the bus 1504 may include any quantity of interconnected buses and bridges, and specifically interconnects various circuits of one or more processors represented by the processor 1501 and a memory represented by the memory 1502. The bus 1504 may be a peripheral component interconnect (PCI) bus, an extended industry standard architecture (EISA) bus, or the like. The bus may be classified into an address bus, a data bus, a control bus, and the like. For ease of representation, the bus is represented by using a thick line in FIG. 15. However, it does not indicate that there is only one bus or only one type of bus. The bus 1504 may further interconnect various other circuits such as a peripheral device, a voltage regulator, and a power management circuit. These are all well known in the art, and therefore are not further described in this specification.

For a problem-resolving implementation and beneficial effects of the terminal device, refer to the implementations and the beneficial effects of the method embodiments of the present disclosure. Therefore, for implementation of the terminal device, refer to the implementation of the method. Repeated parts are not described.

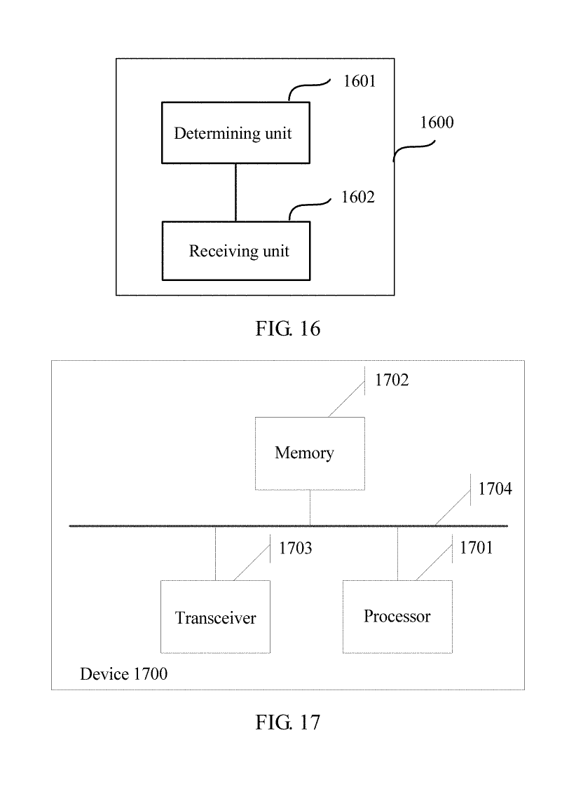

Based on the foregoing embodiments, as shown in FIG. 16, FIG. 16 is a schematic structural diagram of an uplink reference signal transmission apparatus 1600 according to an embodiment of the present disclosure. The apparatus 1600 is applied to a high frequency micro base station in a HetNet scenario in which a high frequency base station is a micro base station and a low frequency base station is a macro base station or a high frequency base station in a networking scenario of only high frequency base stations, and may be configured to perform an execution process of the high frequency micro base station or the high frequency base station in the foregoing method embodiments. The apparatus 1600 includes a determining unit 1601 and a sending unit 1602.

The determining unit 1601 is configured to determine N time slices that are used to receive an uplink reference signal transmitted by a terminal in a single time slice of the terminal, where N is a positive integer greater than 1.

The receiving unit 1602 is configured to switch receive beams in different time slices in the N time slices to receive the uplink reference signal transmitted by the terminal in the single time slice of the terminal, where there is a guard interval at at least one end of the uplink reference signal.

In one embodiment, the receiving unit 1602 is further configured to:

after traversing all receive beams in the single time slice of the terminal, continue to switch a receive beam in a switching sequence of the receive beams to receive the reference signal transmitted by the terminal in the single time slice of the terminal.

The apparatus 1600 in this embodiment of the present disclosure may be an independent component, or may be integrated into another component. For example, the apparatus 1600 provided in this embodiment of the present disclosure may be a base station in an existing communications network, or may be a component integrated into a base station.

It should be noted that, for function implementation and an interaction manner of the units of the apparatus 1600 in this embodiment of the present disclosure, further refer to descriptions in a related method embodiment. Details are not described herein again.

In addition, each foregoing “unit” may be implemented by using an application-specific integrated circuit (ASIC), a processor and a memory that execute one or more software or firmware programs, an integrated logic circuit, and/or another device that can provide the foregoing functions.

As shown in FIG. 17, FIG. 17 is a schematic structural diagram of a network side device 1700 according to an embodiment of the present disclosure. The device 1700 may be configured to perform an execution process of the high frequency micro base station or the high frequency base station in the foregoing method embodiments. The device 1700 may include a base station, or a radio resource management device configured to control a base station.

Referring to FIG. 17, the device 1700 includes a processor 1701, a memory 1702, and a transceiver 1703.

The processor 1701, the memory 1702, and the transceiver 1703 are connected to each other by using a bus 1704.

The transceiver 1703 may implement a function by using a receiver and a transmitter, and the transceiver 1703 may be a wired transceiver, a wireless transceiver, or a combination thereof. The wired transceiver may be, for example, an Ethernet interface. The Ethernet interface may be an optical interface, an electrical interface, or a combination thereof. The wireless transceiver may be, for example, a wireless local area network transceiver, a cellular network transceiver, or a combination thereof.

The processor 1701 may be a CPU, a general purpose processor, a DSP, an ASIC, an FPGA or another programmable logic device, a transistor logic device, a hardware component, or any combination thereof. The memory 1702 may include a volatile memory such as a RAM; or the memory 1702 may include a nonvolatile memory such as a ROM, a flash memory, an HDD, or an SSD; or the memory 1702 may include a combination of the foregoing memories.

The memory 1702 may be configured to store a message received by the transceiver 1703 and a program to be executed by the processor 1701.

The processor 1701 is configured to invoke the program stored in the memory 1702 to perform the following operations: determining N time slices that are used to receive an uplink reference signal transmitted by the terminal in a single time slice of the terminal, where N is a positive integer greater than 1; and switching receive beams in different time slices in the N time slices to receive, by using the transceiver 1703, the uplink reference signal transmitted by the terminal in the single time slice of the terminal, where there is a guard interval at at least one end of the uplink reference signal.

In FIG. 17, the bus 1704 may include any quantity of interconnected buses and bridges, and specifically interconnects various circuits of one or more processors represented by the processor 1701 and a memory represented by the memory 1702. The bus 1704 may be a PCI bus, an EISA bus, or the like. The bus may be classified into an address bus, a data bus, a control bus, and the like. For ease of representation, the bus is represented by using a thick line in FIG. 17. However, it does not indicate that there is only one bus or only one type of bus. The bus 1704 may further interconnect various other circuits such as a peripheral device, a voltage regulator, and a power management circuit. These are all well known in the art, and therefore are not further described in this specification.

In conclusion, in the embodiments of the present disclosure, in a HetNet scenario in which a high frequency base station is a micro base station, and a low frequency base station is a macro base station, a terminal determines a time domain resource sending position of an uplink reference signal of the terminal on a high frequency base station, where there is a guard interval at at least one end of the uplink reference signal; and after arriving at the time domain resource sending position, switches transmit beams in different time slices in M time slices to transmit the uplink reference signal, where the uplink reference signal includes uplink reference signals transmitted in the M different time slices, and M is a positive integer greater than 1. A high frequency base station determines N time slices that are used to receive an uplink reference signal transmitted by the terminal in a single time slice of the terminal; and switches receive beams in different time slices in the N time slices to receive the uplink reference signal of the terminal. In this way, uplink reference signals can be transmitted accurately in different networking scenarios, and a beam detection missing problem caused when an uplink reference signal sent by using a transmit beam cannot be completely received is overcome.

A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a disk memory, a CD-ROM, an optical memory, and the like) that include computer-usable program code.

The present disclosure is described with reference to the flowcharts and/or block diagrams of the method, the device, and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and are performed on the computer or the another programmable device, thereby generating computer-implemented processing. Therefore, the instructions executed on the computer or the another programmable device provide operations for implementing a specific function in one or more processes in the flowcharts and/or in one or more blocks in the block diagrams.

Although some embodiments of the present disclosure have been described, a person skilled in the art can make changes and modifications to these embodiments once they learn the basic inventive concept. Therefore, the following claims are intended to be construed as to cover the embodiments and all changes and modifications falling within the scope of the present disclosure.

Obviously, a person skilled in the art can make various modifications and variations to the embodiments of the present disclosure without departing from the spirit and scope of the embodiments of the present disclosure. The present disclosure is intended to cover these modifications and variations provided that they fall within the scope of protection defined by the following claims and their equivalent technologies.

What is claimed is:

1. A method, comprising:
obtaining, by a terminal, a time domain resource sending position of an uplink reference signal of the terminal on a high frequency link, wherein there is a guard interval at at least one end of the uplink reference signal; and
after arriving at the time domain resource sending position, switching, by the terminal, transmit beams in different time slices in M time slices to transmit the uplink reference signal, wherein the uplink reference signal comprises uplink reference signals transmitted in the M different time slices, and M is a positive integer greater than 1.

2. The method according to claim 1, wherein the guard interval is a duration in which the terminal does not transmit a signal.

3. The method according to claim 1, wherein the uplink reference signal comprises a synchronization reference signal and/or an uplink measurement reference signal.

4. The method according to claim 3, wherein the uplink measurement reference signal comprises a sounding reference signal.

5. The method according to claim 1, wherein a length of the guard interval is not less than a half of an uplink timing advance from the terminal to any high frequency base station.

6. The method according to claim 1, wherein the determining, by a terminal, a time domain resource sending position of an uplink reference signal of the terminal on a high frequency link comprises:
obtaining, by the terminal, a system clock of a low frequency base station based on a low frequency link, and determining a start point position, indicated by the system clock, of a timeslot of the low frequency link as the time domain resource sending position of the uplink reference signal of the terminal on the high frequency link; or
obtaining, by the terminal, a system clock of a low frequency base station and an uplink timing advance of the terminal on a low frequency link based on the low frequency link, and determining, as the time domain resource sending position of the uplink reference signal of the terminal on the high frequency link, a position that is the uplink timing advance after a start point, indicated by the system clock, of a timeslot of the low frequency link; or
receiving, by the terminal, indication information of the time domain resource sending position that is sent by a network side.

7. The method according to claim 1, wherein the transmitting, by the terminal, of the uplink reference signal comprises:
generating a radio frame, wherein the radio frame comprises at least one network-oriented measurement timeslot interval, and the network-oriented measurement timeslot interval comprises the guard interval and a symbol used for uplink reference signal transmission; and
sending the radio frame to transmit the uplink reference signal.

8. A method, comprising:
determining, by a high frequency base station, N time slices that are used to receive an uplink reference signal transmitted by a terminal in a single time slice of the terminal, wherein N is a positive integer greater than 1; and
switching, by the high frequency base station, receive beams in different time slices in the N time slices to receive the uplink reference signal transmitted by the terminal in the single time slice of the terminal, wherein there is a guard interval at at least one end of the uplink reference signal.

9. The method according to claim 8, further comprising:
after traversing all receive beams in the single time slice of the terminal, continuing, by the high frequency base station, to switch a receive beam in a switching sequence of the receive beams to receive the reference signal transmitted by the terminal in the single time slice of the terminal.

10. An apparatus, comprising:
a processor configured to determine a time domain resource sending position of an uplink reference signal of a terminal on a high frequency link, wherein there is a guard interval at at least one end of the uplink reference signal; and
a transmitter configured to after arriving at the time domain resource sending position, switch transmit beams in different time slices in M time slices to transmit the uplink reference signal, wherein the uplink reference signal comprises uplink reference signals transmitted in the M different time slices, and M is a positive integer greater than 1.

11. The apparatus according to claim 10, wherein the guard interval is a duration in which the terminal does not transmit a signal.

12. The apparatus according to claim 10, wherein the uplink reference signal comprises a synchronization reference signal and/or an uplink measurement reference signal.

13. The apparatus according to claim 12, wherein the uplink measurement reference signal comprises a sounding reference signal.

14. The apparatus according to claim 10, wherein a length of the guard interval is not less than a half of an uplink timing advance from the terminal to any high frequency base station.

15. The apparatus according to claim 10, wherein the processor is further configured to:
obtain a system clock of a low frequency base station based on a low frequency link, and determine a start point position, indicated by the system clock, of a timeslot of the low frequency link as the time domain resource sending position of the uplink reference signal of the terminal on the high frequency link;
obtain a system clock of a low frequency base station and an uplink timing advance of the terminal on a low frequency link based on the low frequency link, and determine, as the time domain resource sending position of the uplink reference signal of the terminal on the high frequency link, a position that is the uplink timing advance after a start point, indicated by the system clock, of a timeslot of the low frequency link; or
receive indication information of the time domain resource sending position that is sent by a network side.

16. The apparatus according to claim 10, wherein the transmitter is further configured to:
generate a radio frame, wherein the radio frame comprises at least one network-oriented measurement timeslot interval, and the network-oriented measurement timeslot interval comprises the guard interval and a symbol used for uplink reference signal transmission; and
send the radio frame to transmit the uplink reference signal.

17. An apparatus, comprising:
a processor configured to determine N time slices that are used to receive an uplink reference signal transmitted by a terminal in a single time slice of the terminal, wherein N is a positive integer greater than 1; and
a receiver configured to switch receive beams in different time slices in the N time slices to receive the uplink reference signal transmitted by the terminal in the single time slice of the terminal, wherein there is a guard interval at at least one end of the uplink reference signal.

18. The apparatus according to claim 17, wherein the receiver is further configured to:
after traversing all receive beams in the single time slice of the terminal, continue to switch a receive beam in a switching sequence of the receive beams to receive the reference signal transmitted by the terminal in the single time slice of the terminal.
